(19) United States
(12) Patent Application Publication
(10) Pub. No.: US 2006/0082543 A1
(43) Pub. Date: Apr. 20, 2006

(54) Sensing dynamics associated with a device

(76) Inventors: Curt N. Van Lydegraf, Eagle, ID (US); Thomas W. Ives, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/965,947

(22) Filed: Oct. 14, 2004

(51) Int. Cl. G09G 5/00

(52) U.S. Cl. 345/156

(57) ABSTRACT

A method of sensing dynamics associated with a device is disclosed. The method includes using at least one micro-machined electromechanical systems (MEMS) storage element of a memory module of the device as a motion sensor to detect motion associated with the device. The method further includes processing data output from the MEMS storage element to determine information relating to the dynamics of the device.

### FIELD

This invention relates generally to sensing dynamics associated with a device and, more particularly, to a method of, and a system for, sensing dynamics associated with a device.

### BACKGROUND

Various consumer electronic devices, such as personal digital assistants (PDAs), palm top computers and cellular telephones have a facility whereby data can be entered into the device by a user. The data are entered either by a keypad or by using a stylus on a touch sensitive screen of the device.

A problem with this arrangement is that, because the device has compact dimensions, the keyboard has to be small with the resultant very small keys. It is awkward to use such small keys for the entry of data. A problem with using a stylus is that the stylus needs to be stored on or in the device which unnecessarily increases the bulk of the device. Also, there is a tendency for the stylus to be mislaid. Yet a further problem with a device using a touch sensitive screen is that a new series of data strokes, representative of letters, numbers and punctuation, needs to be learned to enable data to be entered by way of the stylus. These data strokes are often not intuitive and are difficult to memorize.

It has been proposed to use an accelerometer in a consumer electronics device to sense movement of the device for various purposes. However, a problem with this arrangement is that an accelerometer is an expensive piece of equipment, may not be sufficiently sensitive and adds to the cost of the device. The use of an accelerometer in a consumer electronics device of the type described also increases the weight and size of the device which is undesirable.

### SUMMARY

A method of sensing dynamics associated with a device includes using at least one micro-machined electromechanical systems (MEMS) storage element of a memory module of the device as a motion sensor to detect motion associated with the device. The method further includes processing data output from the MEMS storage element to determine information relating to the dynamics of the device.

### BRIEF DESCRIPTION OF THE DRAWINGS

FIG. 1 shows a schematic, three dimensional view of a consumer electronics device including a system, in accordance with an embodiment of the invention, for sensing dynamics associated with the device;

FIG. 2 shows a three dimensional view of part of a memory module for use with the device of FIG. 1, the memory module containing a plurality of micro-electromechanical system (MEMS) storage elements;

FIG. 2A shows a sectional side view of one of the MEMS storage elements taken along line A-A in FIG. 2;

FIG. 2B shows a sectional side view of one of the MEMS storage elements taken along line B-B in FIG. 2;

FIG. 3 shows a block diagram of the memory module;

FIG. 4 shows a block diagram of the system;

FIG. 5 shows a flow chart of a method, in accordance with an embodiment of the invention, for sensing dynamics associated with the device of FIG. 1.

### DETAILED DESCRIPTION OF EXEMPLARY EMBODIMENT

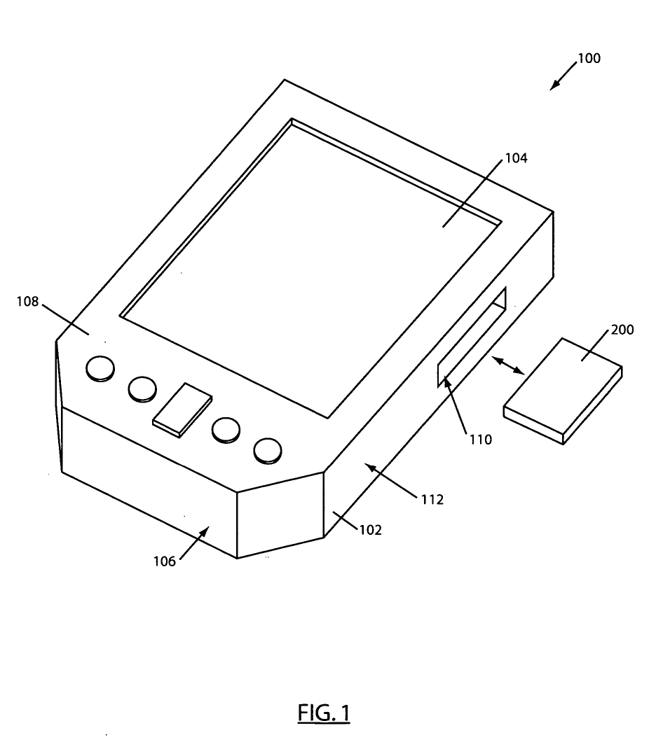

In FIG. 1 of the drawings, reference numeral 100 generally designates a consumer electronics device in the form of a personal digital assistant (PDA). For ease of reference, the invention will be described with reference to its application in the PDA device 100. Those skilled in the art will, however, readily appreciate that the system, in accordance with an embodiment of the invention, can readily be used in numerous other consumer electronics devices.

The device 100 includes a housing 102 containing a display screen 104. A plurality of keys 106 are carried on an upper surface 108 of the housing 102.

A memory module socket 110 is defined in a sidewall 112 of the housing 102 for receiving a removable memory module 200, described in greater detail below.

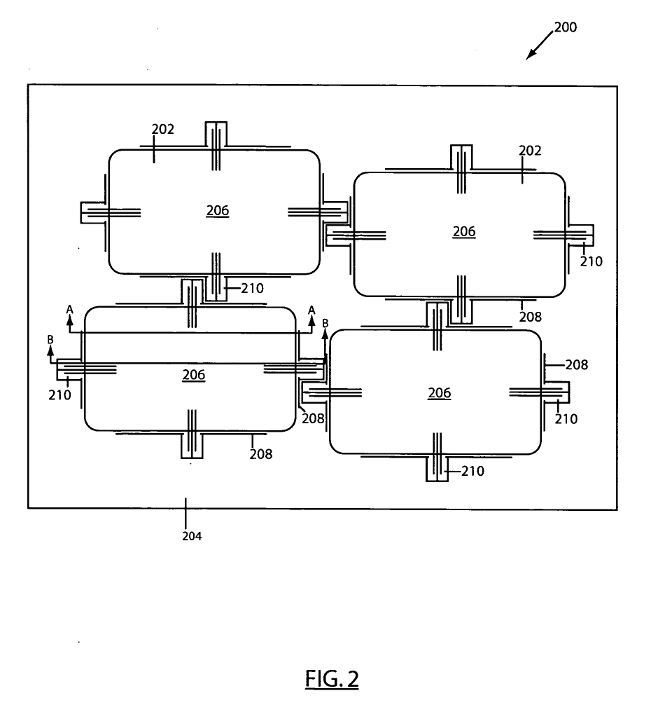

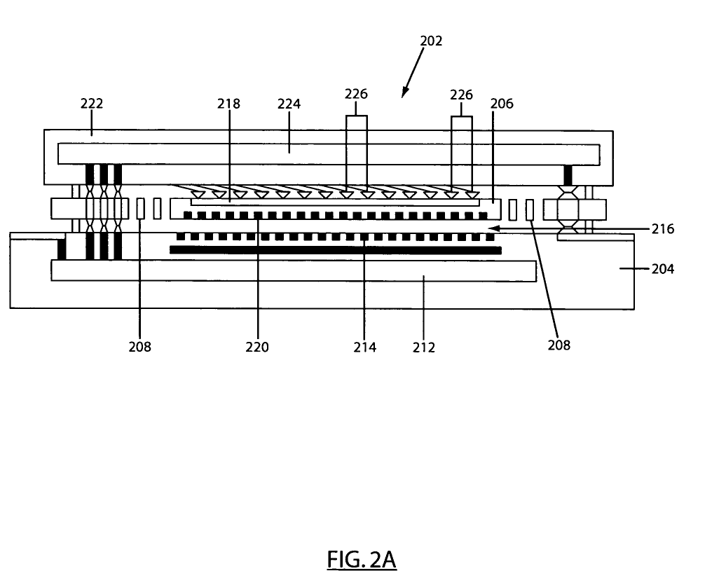

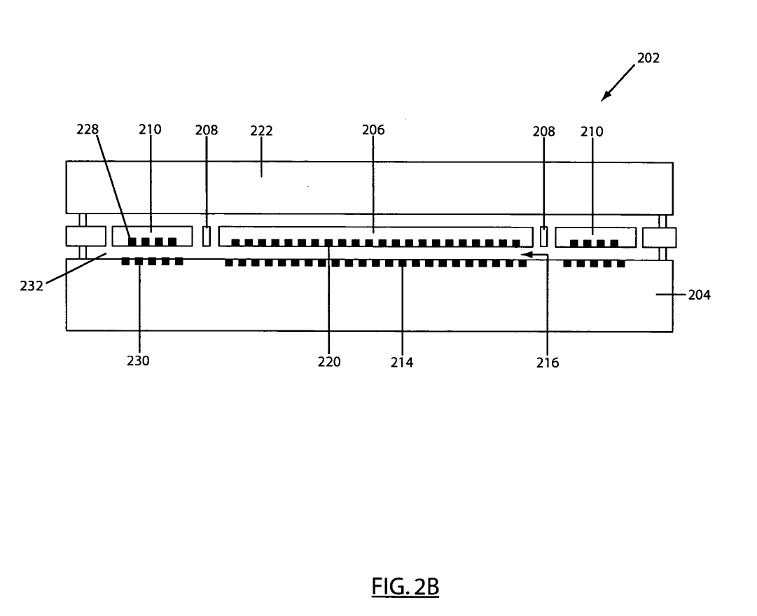

In FIG. 2 of the drawings, reference numeral 200 generally designates a memory module 200 for use with the device 100 of FIG. 1. The memory module 200 includes a plurality of MEMS data storage elements 202. Typically, the memory module 200 includes an array of between 8 and 16 of these MEMS data storage elements 202.

The memory module 200 includes a stator 204 and each data storage element 202 has a driven mover in the form of a rotor 206. The rotors 206 are connected via spring flexures 208 to the stator 204. In addition, coupling blocks 210 are provided interconnecting the rotors 206 to the stator 204.

As shown in FIGS. 2A and 2B of the drawings, the stator 204 contains stator electronics 212. In addition, the stator 204 supports a plurality of stator electrodes 214 forming a first part of a control arrangement, in the form of an electrostatic motor 216, of the data storage element 202.

As described above, the rotor 206 is supported relative to the stator 204 by the spring flexures 208. The rotor 206 carries a media layer 218 which acts as a data storage component of the memory module 202. In addition, a surface of the rotor 206 facing the stator 204 carries rotor electrodes 220 forming the second part of the electrostatic motor 216.

The data storage element 202 has a cantilever die, or lid die, 222 overlying the rotor 206. The lid die 222 supports tip selection circuitry 224 and a plurality of cantilevered addressing tips 226 suspended from the lid die 222. The addressing tips 226 are used for writing data to the media layer 218 of the rotor 206 and for reading stored data from the media layer 218 of the rotor 206.

As shown in FIG. 2B of the drawings, each coupling block 210 carries a plurality of rotor capacitor sensor plates 228 which are associated with stator capacitor sensor plates 230 carried on the stator 204 of the data storage element 202 to form capacitors 232. It is to be noted that certain parts of the data storage element 202 have been omitted from FIG. 2B for the sake of clarity.

When data is to be written to the media layer 218 of the rotor 206, the electrostatic motor 216 of the data storage element 202 is activated. This causes the rotor 206 to be displaced relative to the stator 204 to bring the desired region of the media layer 218 into position relative to the tips 226 to enable the data to be written to the media layer 218. The rotor 206 moves against the action of the spring flexures 208 and the position of the rotor 206 relative to the stator 204 is controlled by sensing the change in capacitance of the capacitors 232. In this way, the position of the rotor 206 relative to the stator 204 can be accurately controlled. A similar procedure is followed when it is desired to read data from the media layer 218 of the data storage element 202.

At any one time, only some of the data storage elements 202 of the memory module 200 are being addressed for reading or writing purposes. The remaining data storage elements 202 are not being used.

When any data storage element 202 is not being used for storage, it can be used as an accelerometer and either a position control loop provided by the electrostatic motor 216 or the change in capacitance of the capacitors 232 on its own can be used to report acceleration information of the device 100 as will be described in greater detail below. This acceleration information can then be used to provide control of the PDA device 100 and can therefore be used as a data input mechanism for the PDA device 100.

The electrostatic motor 216 of the data storage element 202 controls both the X and Y positions of the rotor 206 relative to the stator 204.

As described above, when the rotor 206 moves relative to the stator 204, a change in capacitance of the capacitors 232 is generated in each of the X and Y directions.

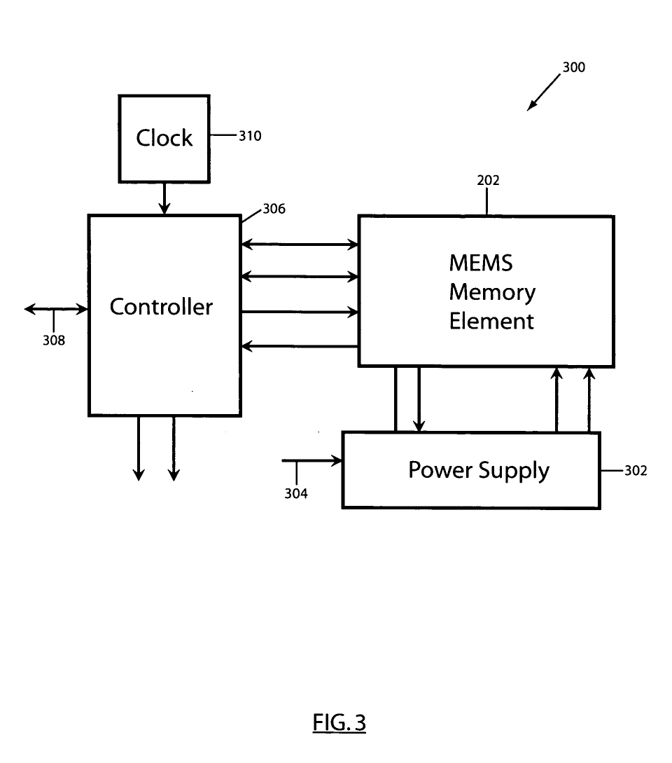

In FIG. 3 of the drawings, a system block diagram of the memory module 200 is shown and is designated generally the reference numeral 300. The system 300 includes the data storage elements 202. The electrodes 214 and 220 of the electrostatic motor 216 of each data storage element 202 are connected to a power supply 302. The power supply 302 provides power to the electrodes 214, 220 to cause the rotor 206 to be displaced relative to the stator 204 and the tips 226 to enable data to be written to or read from the media layer 218 of the rotor 206. The power supply 302 receives power from a power supply of the PDA device 100 as shown by line 304.

The selection circuitry 224 of the roof section 222 is addressed by a controller 306 which communicates via an interface 308 with the PDA device 100. The controller 306 is controlled by a clock oscillator 310.

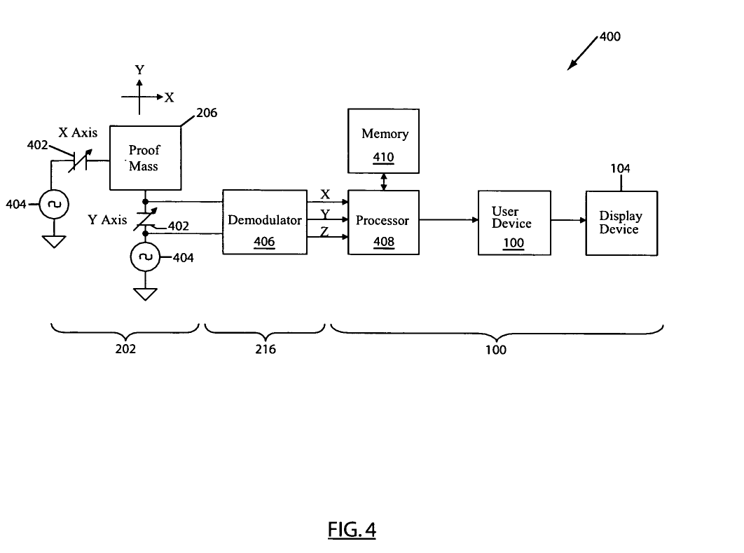

In a system 400 (FIG. 4) for sensing dynamics of the device 100, the capacitors 232 in the X and Y directions are shown as variable capacitors 402. For the sake of clarity, only the Y axis implementation is shown. The X axis implementation is identical and Z axis information is obtained from a combination of X and Y data.

Each variable capacitor 402 has a sinusoidal carrier from a source 404 applied to it to measure the change in capacitance as the rotor 206 moves relative to the stator 204. An output from the variable capacitor 402 is fed to a demodulator 406, the demodulator 406 being implemented as part of the stator electronics 212. An output from the demodulator 406, in turn, is fed to a processor 408 of the device 100. The processor 408 has a memory 410 associated with it. A table of acceptable movement patterns and/or motions of the PDA device 100 is stored in the memory 410.

When the data storage element 202 is being used as an accelerometer, the acceleration information is derived from the following equation:
F=M*a=K*dx

Rearranging this equation provides:
a=K*dx/M
where:

M=the mass of the rotor 206;

k=the spring constant of the flexures 208;

dx=the displacement of the rotor 206 in either X or Y direction; and

a=the acceleration of the rotor 206.

The above equation arises from the fact that an external force acting on the rotor 206 causes an acceleration of the rotor 206. This force is balanced by the spring force exerted by the flexures 208. Therefore, the acceleration of the rotor 206 can be determined. The acceleration of the rotor 206 can be determined by one of two methods.

The first method uses the change in capacitance of the variable capacitors 402 only. The change in capacitance provides an indication of the movement of the rotor 206 relative to the stator 204. This gives rise to a simple open-loop positioning system. The system is, however, subjected to non-linear effects arising from the spring flexures 208.

The spring constant K is a function of temperature and is non-linear as a function of change in direction X or direction Y. This results in an accelerometer which reads the change in direction but provides an acceleration value which is not absolute. However, as the accelerometer is being used in an application where an absolute acceleration value is not essential, the use of the open loop system may suffice. This is also because, as will be described in greater detail below, it is of more interest to determine the direction of movement of the device 100 than to know the absolute acceleration value of the movement of the device 100.

The other method of using the data storage element 202 as an accelerometer is to close the loop on the rotor 206 and stator 204. This means that the electrostatic motor 216 that drives the rotor 206 relative to the stator 204 in X and Y directions is used to hold the rotor 206 in the centre of its excursion range, i.e. the most relaxed point of the flexures 208. In this method, the effects of the spring flexures 208 are not an issue since they do not experience a significant “dx” term. The position is essentially static.

A servo system, forming a part of the stator electronics 212, that counteracts the external acceleration forces creates a signal, commonly called a command signal, that drives the electrostatic motor 216 to its neutral position. The command signal is proportional to the acceleration value. This command signal is demodulated by the demodulator 406 for further processing by the processor 408.

In use, when it is desired to sense the dynamics of the device 100, an appropriate command is sent by the processor 408 to cause one of the data storage elements 202 of the memory module 200 to function as an accelerometer. As indicated above, the data storage element 202 which is selected to act as an accelerometer is one which is not being used for reading or writing data.

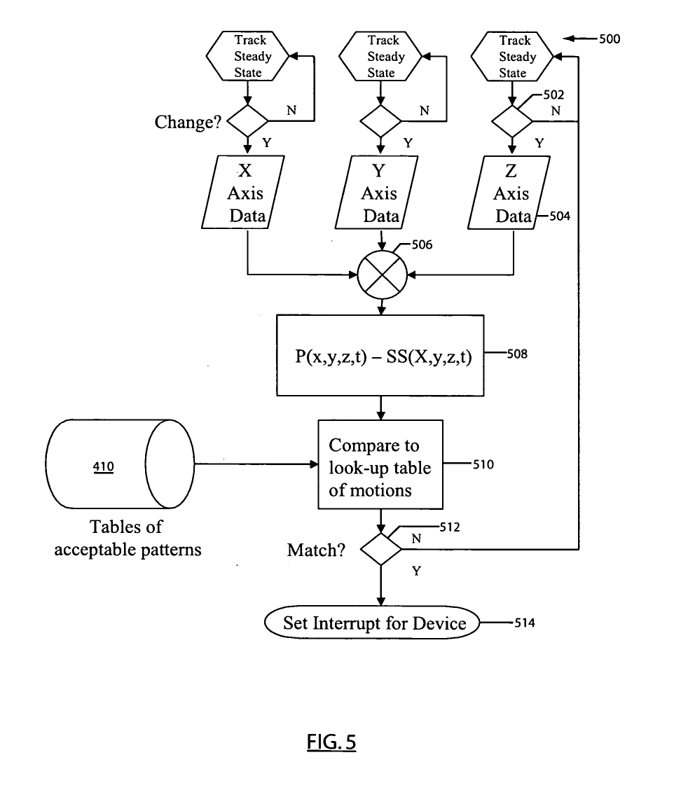

FIG. 5 is a flowchart of a method of sensing dynamics associated with a device. At step 500, the output of the data storage element 202 is tracked to detect any deviation from steady state conditions, in each of the X, Y and Z directions. At step 502, a determination is made as to whether or not there has been any change from the steady state conditions. If so, at step 504, dynamic motion data are obtained for each of the X, Y and Z directions. These data from steps 504 are combined at step 506 into a position vector.

The processor 408 then subtracts the steady state position offsets from the dynamic position to determine the dynamic motion at step 508. Once the dynamic motion has been determined, a comparison is made between the dynamic motion and the contents of the memory 410 to determine the motion which has been imparted to the device 100. A determination is made at step 512 whether or not there is a match between the detected, dynamic motion and the data stored in the memory 410. If not, the device 100 is returned to its steady state tracking at step 500. If there is a match, at step 514 an interrupt for the device 100 is set to alert the device 100 that there is a user input that needs to be considered.

The use of the data storage element 202 as an accelerometer can be used to effect dynamic control of the device 100. For example, the following actions can be carried out on the device 100 resulting in the following device functions:

| Motion | Resulting Device Function |
|---|---|
| Small tip up | Scroll one line up |
| Large tip up | Scroll one screen up |
| Small tip down | Scroll one line down |
| Large tip down | Scroll one screen down |
| Store device upside down | Turn off all audible beeps |
| Turn upside down and shake | Erase document |
| Move device away | Zoom out |
| Move device closer | Zoom in |
| Start an Alarm function and place device | Alarm active |
| face up | |
| Turn device face down | Snooze |
| Tilt device PDA in x and y directions | Joystick control |

Yet another action which can be carried out on the device 100 using one of the data storage elements 202 as an accelerometer is the entry of data into the device 100. For example, by moving the device 100 in the shape of a letter of the alphabet, that letter can be written on the screen 104 of the device 100. Thus, for example, if a user wishes to enter the letter “S”, the user simply draws the letter in the air moving the device 100 in the required serpentine manner. This is detected by the data storage element 202 acting as an accelerometer. Thus, a further benefit of the embodiment of the invention is that it can be used to enable data input for small devices that do not have touch screens or keypads.

The same action can be used to access particular information, for example, entries in a telephone directory of the device 100 beginning with a predetermined letter. By moving the device 100 in the shape of the required letter of the alphabet, the listings in the telephone directory starting with that letter are obtained. To then access the desired entry, a cursor on the screen 104 is moved by small tilts of the device 100.

Yet another application of an embodiment of the invention is the use of the PDA device 100 as a device for making several types of measurements. For example a jogger out on a run could carry the device 100 with him or her to use as a pedometer. Each foot fall is logged by the data storage element 202 functioning as an accelerometer. With a value for the average jogging stride, the system 400 can estimate the distance travelled. By integrating the acceleration information, the system 400 could also record the velocity of the jogger.

Thus by simply pushing a button, the jogger can start a distance measure and when the button is pushed a second time the estimated total distance would be displayed on the display screen 104.

Still a further application is the use of the PDA device 100 on a mechanical system. By placing the PDA device 100 on an item that has a vibration or knock, the device 100 can be used to report the frequency response of the vibration. This information can be recorded on the device 100 for subsequent analysis. Thus, the PDA device 100 can function as a vibration analyser.

It is a major advantage of the varying embodiments of invention that a system 400 is provided which does not require any increase in the size of the consumer electronics device 100. Very few, if any, hardware modifications are implemented. Merely by using an appropriate memory module 200, i.e. one including the MEMS data storage elements 202 and by reconfiguring the software associated with the processor 408 of the device 100, the system 400 can be implemented. Thus the size and weight of the device 100 is not increased at all. Neither are the costs significantly greater than using the device 100 with other types of memory modules.

As indicated above, another advantage of the system 400 is that it can be used for data access or data entry into consumer electronics devices which do not have touch sensitive screens and/or keypads.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

What is claimed is:

1. A method of sensing dynamics associated with a device, the method comprising
using at least one micro-machined electromechanical systems (MEMS) storage element of a memory module of the device as a motion sensor to detect motion associated with the device; and
processing data output from the MEMS storage element to determine information relating to the dynamics of the device.

2. The method of claim 1 which includes operating the MEMS storage element as an accelerometer and processing an output from the accelerometer to obtain dynamics information relating to the device.

3. The method of claim 2 in which the memory module of the device includes a plurality of MEMS storage elements and in which the method includes using any one of the MEMS storage elements not being used for data storage as the accelerometer.

4. The method of claim 2 in which a control arrangement is associated with the MEMS storage element and in which the method includes processing data output from the control arrangement to provide the dynamics information.

5. The method of claim 4 in which the MEMS storage element has a driven mover and the control arrangement comprises a driver for controlling movement of the mover and in which the method includes using a signal generated by the driver to provide an indication of the acceleration of the mover.

6. The method of claim 1 which includes using the data output from the MEMS storage element to control the device.

7. A system for sensing dynamics associated with a device, the system comprising
at least one MEMS storage element of a memory module of the device operable as a motion sensor to detect motion associated with the device; and
a processor in communication with the MEMS storage element for processing data output from the MEMS storage element to determine information relating to the dynamics of the device.

8. The system of claim 7 in which the MEMS storage element is operable as an accelerometer with an output from the accelerometer being processed by the processor to obtain dynamics information relating to the device.

9. The system of claim 8 in which the memory module of the device includes a plurality of MEMS storage elements, any one of the MEMS storage elements not being used for data storage being used as the accelerometer.

10. The system of claim 8 which includes a control arrangement associated with the MEMS storage element.

11. The system of claim 10 in which the MEMS storage element has a driven mover and the control arrangement comprises a driver for controlling movement of the mover.

12. The system of claim 7 in which the device is responsive to commands from the processor.

13. A system for sensing dynamics associated with a device, the system comprising
at least one MEMS storage means of a memory means of the device operable as a motion sensing means to detect motion associated with the device; and
a processing means in communication with the MEMS storage means for processing data output from the MEMS storage means to determine information relating to the dynamics of the device.

14. A device which comprises
a housing;
a memory module received in the housing, the memory module comprising at least one MEMS storage element;
an addressing module for addressing the MEMS storage element to cause the MEMS storage element to operate as a motion sensor to detect motion of the housing; and
a processor in communication with the MEMS storage element to provide information relating to dynamics associated with the housing.

15. The device of claim 14 in which the MEMS storage element is operable as an accelerometer with an output from the accelerometer being processed by the processor to obtain dynamics information associated with the housing.

16. The device of claim 15 in which the memory module includes a plurality of MEMS storage elements, any one of the MEMS storage elements not being used for data storage being used as the accelerometer.

17. The device of claim 15 which includes a control arrangement associated with the MEMS storage element.

18. The device of claim 17 in which the MEMS storage element has a driven mover and the control arrangement comprises a driver for controlling movement of the mover.

19. The device of claim 14 which is responsive to commands from the processor.

20. The device of claim 14 in which the addressing module and the processor are implemented as a single module.

21. The device of claim 14 in which the memory module is removably received in the housing.

22. A device which comprises
a housing means;
a memory means received in the housing means, the memory means comprising at least one MEMS storage means;
an addressing means for addressing the MEMS storage means to cause the MEMS storage means to operate as a motion sensor to detect motion of the housing means; and
a processing means in communication with the MEMS storage means to provide information relating to dynamics associated with the housing means.

23. A consumer electronics device which comprises
a memory module having at least one MEMS storage element;
an addressing module for addressing the MEMS storage element to cause the MEMS storage element to operate as a motion sensor to detect motion associated with the device; and
a processor in communication with the MEMS storage element to provide information relating to the dynamics of the device.
